(19) United States
(12) Patent Application Publication
(10) Pub. No.: US 2003/0200849 A1
(43) Pub. Date: Oct. 30, 2003

(54) Reinforcing steel bar cutter

(76) Inventor: Minoru Kochi, Sanjo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/192,648

(22) Filed: Jul. 11, 2002

(30) Foreign Application Priority Data
Apr. 30, 2002 (JP) 2002-002483

(51) Int. Cl. B26D 1/00

(52) U.S. Cl. 83/199; 83/196; 83/200

(57) ABSTRACT

A reinforcing steel bar cutter includes a base, a pair of bearing plates erected on the base, a handle shaft pivotally attached to one of the pair of bearing plates, a stationary blade and a movable blade provided with depressed parts and interposed between the pair of bearing plates, and a posture-retaining wall formed on at least one of the pair of bearing plates for preventing the reinforcing steel bar inserted into the depressed parts from warping while the reinforcing steel bar is being cut. The stationary and movable blades have opposed cutting blade parts to each of which a relief angle is imparted. The movable blade is connected to the handle shaft and rotated relative to the stationary blade by rocking motion of the handle shaft to cut the reinforcing bar.

### BACKGROUND OF THE INVENTION

1. Field of the Invention

The present invention relates to a reinforcing steel bar cutter that is used at a building site, for example, for the purpose of cutting a reinforcing steel bar in a necessary length.

2. Description of Prior Art

As a conventional reinforcing steel bar cutter of this type, what is disclosed in JP-A SHO 60-190519 (UM), for example, has existed.

The conventional reinforcing steel bar cutter comprises a cutter body having a base, a pair of bearing plates erected on the base, a pair of stationary and movable blades that are interposed between the bearing plates, and a handle shaft to which the movable blade is connected via a link. The handle shaft is pivotally fitted to the bearing plates. The stationary and movable blades each have a depressed part formed therein. A rocking motion imparted to the handle shaft enables the movable blade to be rotated relative to the stationary blade.

In actual use of the conventional reinforcing steel bar cutter, an upward rocking motion is imparted to the handle shaft till the depressed parts coincide with each other. Then, with a given reinforcing steel bar inserted into the depressed parts, a downward rocking motion is imparted to the handle shaft. As a result, the movable blade is rotated in the cutting direction thereof to enable the reinforcing steel bar to be cut in a necessary length by the cooperation of the movable blade and the stationary blade.

The conventional reinforcing steel bar cutter, therefore, is at an advantage in being capable of cutting a reinforcing steel bar with a comparatively simple structure. It nevertheless has the possibility of dispersing the cutting force thereof and failing to produce a fully satisfactory quality of cutting. The reason therefor will be described with reference to FIG. 6, in which a stationary blade 31 and a movable blade 33 have depressed parts 32 and 34, respectively. The portions of the blades 31 and 33 serving as cutting blade parts are opposed in parallel to each other across the depressed parts 32 and 34. The parallel cutting blade parts, in cutting a reinforcing steel bar R, inevitably come into face contact with the reinforcing steel bar R.

An object of the present invention is to provide a reinforcing steel bar cutter that can effectively solve the problems that confront the conventional reinforcing steel bar cutter.

### SUMMARY OF THE INVENTION

A reinforcing steel bar cutter, comprising: a base; a pair of bearing plates erected on the base; a handle shaft pivotally attached to one of the pair of bearing plates; a stationary blade and a movable blade interposed between the pair of bearing plates, the stationary and movable blades having depressed parts in which a reinforcing bar is inserted and having opposed cutting blade parts to each of which a relief angle is imparted, the movable blade being connected to the handle shaft and rotated relative to the stationary blade by rocking motion of the handle shaft to cut the reinforcing bar; and a posture-retaining wall formed on at least one of the pair of bearing plates for preventing the reinforcing steel bar inserted into the depressed parts from warping while the reinforcing steel bar is being cut.

In this invention, therefore, owing to the impartation of relief angles to the opposed cutting blade parts of the stationary and movable blades, the cutting force is concentrated so much as to enable a given reinforcing steel bar to be cut sharply. As a result, the quality of cutting is markedly improved as compared with that obtained with the conventional cutter acquiring parallel cutting blade parts, and the cutting can be attained with a light force.

It is conceivable that the reinforcing steel bars are possibly suffered to warp when they are cut in the presence of relief angles. In this case, the formation on either of the bearing plates of the posture retaining wall capable of preventing the reinforcing steel bars from warping will be at an advantage in eliminating the loss of the cutting force possibly occurring when the bars are suffered to warp. This enables the cutting to be attained with a small cutting force.

### BRIEF DESCRIPTION OF THE DRAWINGS

FIG. 1 is a perspective view illustrating the essential part of a reinforcing steel bar cutter according to a preferred embodiment of this invention, as viewed from the front side.

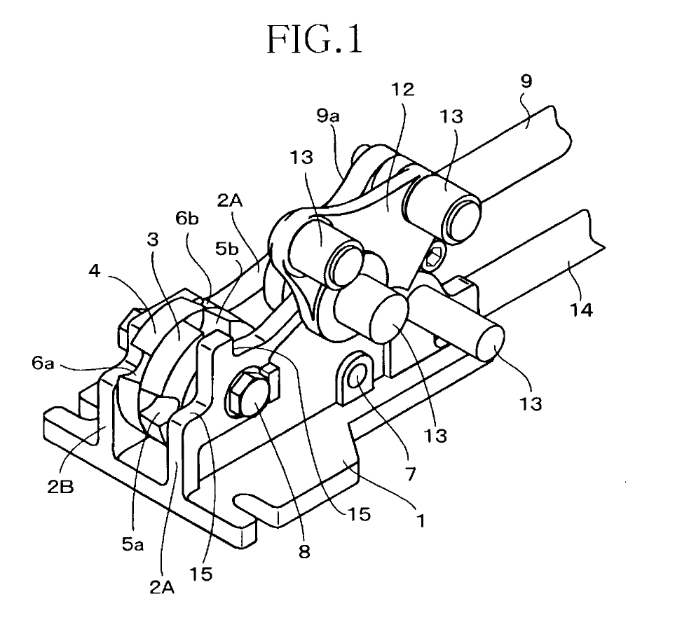

FIG. 2 is a perspective view of the essential part of the reinforcing steel bar cutter, as viewed from the rear side.

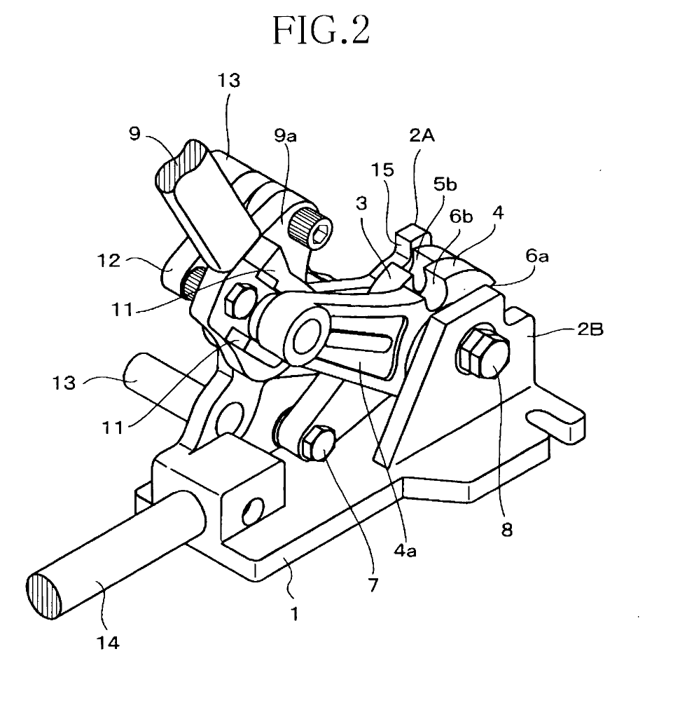

FIG. 3 is a side view of the reinforcing steel bar cutter.

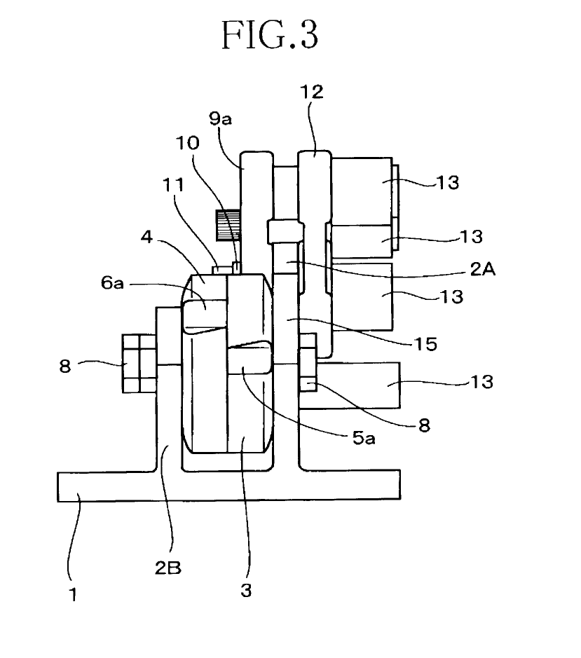

FIG. 4 is a plan view illustrating the essential part of the opposed blade shapes formed as cutting blade parts on the depressed parts sides of a stationary blade and a movable blade.

FIG. 5 is a front view illustrating the essential part of the state of the insertion of a reinforcing steel bar into the depressed parts formed in consequence of the coincidence of the depressed parts of the stationary blade and the movable blade.

FIG. 6 is an explanatory diagram intended to aid in explaining the cutting blade parts of the stationary and movable blades of a conventional reinforcing steel bar cutter, which parts are opposed in parallel to each other across the depressed parts.

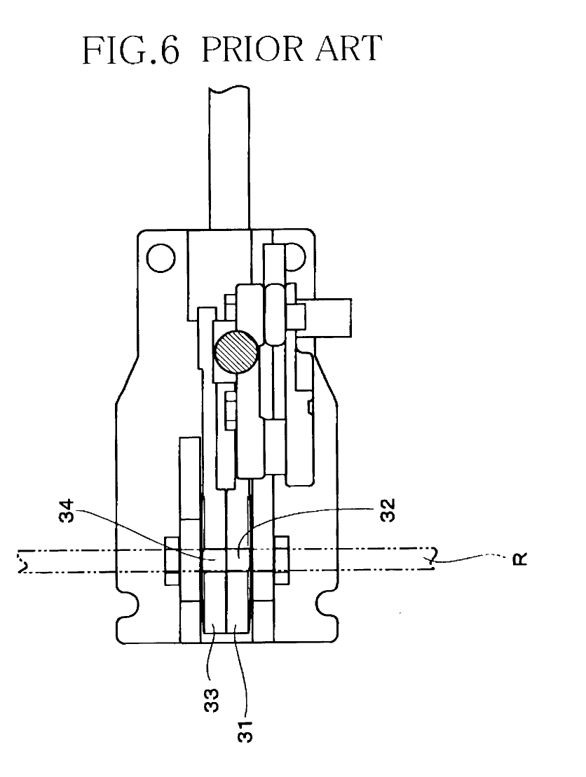

### DETAILED DESCRIPTION OF THE PREFERRED EMBODIMENT

Now, this invention will be described specifically below based on the illustrated preferred embodiment. The reinforcing steel bar cutter according to this embodiment also consists in erecting a pair of bearing plates 2A and 2B on a base 1 and interposing a stationary blade 3 and a movable blade 4 between the bearing plates 2A and 2B. Concerning the stationary blade 3, two types of depressed parts 5a and 5b differing in the diameter for insertion of a reinforcing steel bar are formed as spaced along the circumference, and projecting arm parts thereof (not shown) are fixed on the bearing plate 2A through a shaft 7. Concerning the movable blade 4, two kinds of depressed parts 6a and 6b differing in the diameter for insertion of a reinforcing steel bar are similarly formed along the circumference and pivotally supported on the stationary blade 3 through a shaft 8.

A handle shaft 9 has a widened distal part 9a pivotally fitted in a shakable manner to the bearing plate 2A through a shaft 10. The movable blade 4 has a projecting arm part 4a whose distal end is slidaly fitted inside a pair of guide rails 11. The guide rails 11 are disposed on the widened distal end part 9a of the handle shaft 9. With this configuration, the handle shaft 9 is allowed to produce a rocking motion, making it possible to slide the projecting arm part 4a on the guide rails 11 and set the movable blade 4 rotating relative to the stationary blade 3.

In the drawings, reference numeral 12 denotes a fitting plate integrally disposed on the widened distal end part 9a of the handle shaft 9. Numeral 13 denotes a bending shaft that bends, to a necessary angle, a reinforcing steel bar fitted to the fitting plate 12 and the bearing plate 2A, and numeral 14 denotes a foot shaft adapted to be depressed with a foot during the work of cutting a reinforcing steel bar.

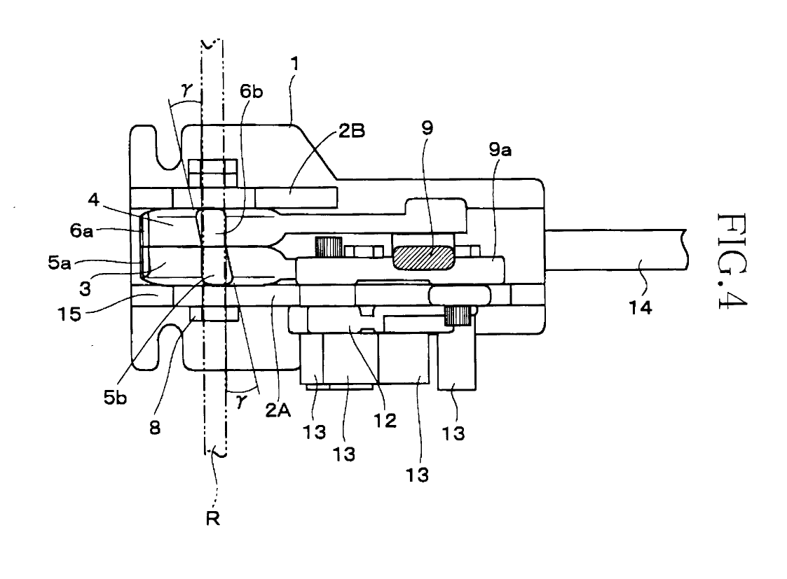

The present embodiment that has the construction described above as the precondition, imparts a relief angle γ to the opposed cutting blade parts of the stationary and movable blades 3 and 4 as illustrated in FIG. 4. Therefore, the stationary and movable blade 3 and 4 concentrate the cutting force till they cut the reinforcing steel bar in a necessary length. Posture-retaining walls 15 are formed at the neighboring portions corresponding to the depressed parts 5a and 5b of the stationary blade 3 of the bearing plate 2A. The walls 15 fulfill the function of preventing the reinforcing steel bars inserted in the depressed parts 5a and 5b from warping during the work of cutting.

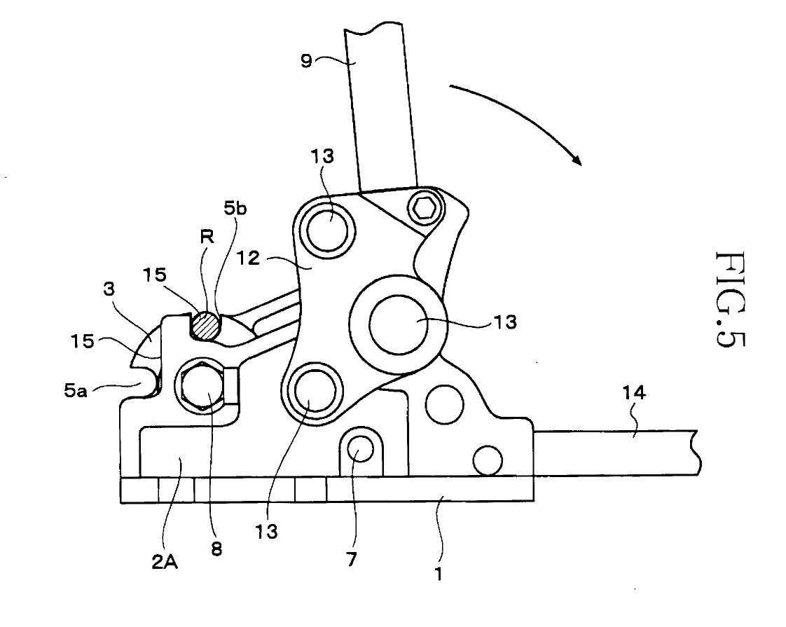

At the actual construction site, therefore, proper depressed parts 5b and 6b of the stationary and movable blades 3 and 4 are first selected in conformity with the particular diameter of the reinforcing steel bars given to be cut. An upward rocking motion is then given to the handle shaft 9 pivotally fitted to the bearing plate 2A till the depressed parts 5b and 6b coincide with each other as illustrated in FIG. 4 and FIG. 5. A reinforcing steel bars R is then inserted into the relevant depressed parts 5b and 6b, and the handle shaft 9 is given a downward (in the direction of the arrow mark) rocking motion, thereby rotating the movable blade 4 in the cutting direction. As a result, the movable blade 4 and the stationary blade 3 cut the reinforcing steel bar R in the necessary length.

In this case, however, the present embodiment is enabled to concentrate the cutting force and cut the reinforcing steel bar R sharply owing to the formation of the relief angle y in the opposed cutting blade parts of the stationary the movable blades 3 and 4 as described above. Therefore, it further improves the quality of cutting and allows the cutting to be effected with a light force as compared with the conventional reinforcing steel bar cutter that acquires parallel cutting blades. Incidentally, though the relief angle γ is decided by the relation thereof with the strength of the blade, it is generally preferred to be in the range of 8°-15°.

It is conceivable that when the reinforcing steel bars R are cut in the presence of the relief angle γ, they will possibly warp. However, the posture-retaining wall 15 capable of preventing the reinforcing steel bar R from warping is formed on the bearing plate 2A. Therefore, if the reinforcing steel bar R is cut in a correct state, the loss of the cutting force that occurs when the bar is suffered to assume a warped state can be eliminated.

When the reinforcing steel bar R is required to be bent, it can be bent to 90°, 135° or 180° with one step or two steps by nipping the reinforcing steel bar R between the bending shafts 13 and then giving a downward rocking motion to the handle shaft 9.

This invention, owing to the adoption of the construction described above and the impartation of the relief angle to the opposed cutting blade parts of the stationary and the movable blades as described above, is enabled to concentrate the cutting force and cut the reinforcing steel bar sharply. Thus, the quality of cutting is further improved and the cutting of the reinforcing steel bar is attained with a light force as compared with the conventional reinforcing steel bar cutter that acquires parallel cutting blade parts.

It is conceivable that when the reinforcing steel bar is cut in the presence of the relief angle, it will be possibly suffered to warp. However, the cutting of the reinforcing steel bar in a correct posture is warranted owing to the formation on the bearing plate of the posture-retaining wall capable of preventing the reinforcing steel bar from warping. Therefore, the cutting with a light force can be realized by eliminating the loss of the cutting force that occurs when the cutting is made while the reinforcing steel bar is in a warped state.

What is claimed is:

1. A reinforcing steel bar cutter, comprising:
a base,
a pair of bearing plates erected on the base,
a handle shaft pivotally attached to one of the pair of bearing plates,
a stationary blade and a movable blade interposed between the pair of bearing plates, the stationary and movable blades having depressed parts in which a reinforcing bar is inserted and having opposed cutting blade parts to each of which a relief angle is imparted, the movable blade being connected to the handle shaft and rotated relative to the stationary blade by rocking motion of the handle shaft to cut the reinforcing bar, and
a posture-retaining wall formed on at least one of the pair of bearing plates for preventing the reinforcing steel bar inserted into the depressed parts from warping while the reinforcing steel bar is being cut.
